(19) United States
(12) Patent Application Publication
(10) Pub. No.: US 2012/0083146 A1
(43) Pub. Date: Apr. 5, 2012

(54) Block mounted adjustable end

(76) Inventor: Norman R. Byrne, Ada, MI (US)

(21) Appl. No.: 13/373,259

(22) Filed: Nov. 9, 2011

Related U.S. Application Data
(63) Continuation of application No. 12/894,963, filed on Sep. 30, 2010, now abandoned.

(51) Int. Cl. H01R 11/00

(52) U.S. Cl. 439/214

(57) ABSTRACT

A block mounted adjustable end assembly (300) includes a first end jumper cable assembly (302) having a set of conductive wires (305) extending therethrough. The first end jumper cable assembly (302) is connected to a junction block assembly (306). The junction block assembly (306) includes a junction block (310) and an adjustment end block (318) secured to the junction block (310). A storage excess (340) of said conductive wires (305) is looped and stored within an interior (338) of said adjustment end block (318). The adjustment end block (318) is connected to a second end jumper cable assembly (320) having an extendable conduit (323) with the conductive wires (305) extending therethrough and terminating at a male end connector (324). Extension of the conduit (323) causes the slack of the storage excess (340) of the conductive wires (305) to be taken up within the length of the conduit (323).

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCE TO MICROFISHE APPENDIX

Not applicable.

### BACKGROUND OF THE INVENTION

1. Field of the Invention

The invention relates to electrical power and communications distribution systems and, more particularly, to systems having junction blocks and cable assemblies where it is desirable to adjust the length of a cable assembly.

2. Background Art

Known interior wall systems typically employ pre-fabricated modular units. These units are often joined together in various configurations, so as to divide a workplace into smaller offices or work areas. Generally, such modular wall panels may be equipped with means for receiving general building power and, possibly, general communications. Such building power may, for example, be conventional AC power received either under floor or from relatively permanent walls or the like. In various types of environments comprising electrical equipment, or wherein electrical apparatus are otherwise employed, interconnections of electrical components to incoming utility power are typically provided by means of cables or wires. For example, in office systems compromising modular furniture components, it is often necessary to provide electrical interconnections between incoming power supplies and various types of electrical devices typically used in an office environment, such as electric typewriters, lamps, etc. Computer-related devices, such as video display terminals and similar peripherals, are also now commonly employed in various office and industrial environments.

One advantage inherent in modular office systems is the capability to rearrange furniture components as necessitated by changes in space requirements, resulting from changes in the number of personnel and other business-related considerations. However, these modular systems must not only allow for change in furniture configurations, but also must provide for convenient interconnection of electrical devices to utility power, regardless of the spacial configuration of the modular systems and resultant variable distances between electrical devices.

In this regard, it is known to provide modular wall panels with areas characterized as raceways. Often, these raceways are located along bottom edges of modular panels. The raceways are adapted to house electrical cabling and electrical junction blocks. The cabling and junction blocks are utilized to provide electrical outlets and electrical power connections to adjacent panels. However, it is also apparent that to the extent reference is made herein to providing electrical outlets and electrical power connections for adjacent panels, the same issues exist with respect to providing communications among panels.

Still further, it is known that the raceway of one modular wall unit may be provided with a male connector at one end, and a female connector at another end. Junction blocks, each provided with electrical outlets, may be disposed at spaced-apart positions along the raceway. Conduits or jumper cable assemblies may be extended between the junction blocks and between the connectors in the junction blocks. In this manner, electrical interconnection is provided between the units.

The modular panels of a space-divider may be configured, such that adjacent panels are in a straight line, or at various angular positions relative to each other. It is common to configure intersecting walls in such a fashion that three or four modular wall panels may intersect at right angles. Each of the panels typically requires electrical outlets, and may require outlets on both sides of the panels. In any event, electrical power has to be provided to all of the panels, and often only one of the panels at the multiple panel junction is connected to a power supply source. Under such circumstances, the interconnecting wiring becomes a significant problem. That is, special modifications may have to be made to power systems of wall panels to be used in such a configuration. Because interchangeability of wall panels is highly desirable, custom modifications are preferably avoided. Still further, modifications of wall panels on site at the installation facility is complex and may be relatively expensive.

In addition to the foregoing issues, problems can arise with respect to the use of junction blocks and the amount of room which may exist within a raceway. That is, raceways require sufficient room so as to provide for junction blocks, electrical outlet receptacle blocks, and cabling extending between junction blocks and between adjacent panels.

A number of systems employing what could be characterized as junction blocks and jumper cable assemblies currently exist in the prior art. For example, Nienhuis, et al., U.S. Pat. No. 5,013,252, issued May 7, 1991, discloses an electrified wall panel system having a power distribution server located within a wall panel unit. The server includes four receptacle module ports oriented in an H-shaped configuration. A first receptacle port is located on the first side of the wall panel unit and opens toward a first end of the unit. A second receptacle unit is also located on the first side of the wall panel unit, and opens toward a second end of the wall panel unit. A third receptacle port and a second sided wall panel unit opens toward the first end of the wall panel unit, while correspondingly, a fourth receptacle port on the second side of the wall panel unit opens toward the second end of the wall panel unit. First and second harnesses are each electrically connected at first ends thereof to the power distribution server. They extend to opposite ends of the wall paneled unit and include connector ports on the second ends thereof for providing electrical interconnection of adjacent wall panel units. The Nienhuis, et al. patent also discloses a system with a wall panel connector interchangeably usable with the interconnection of two, three or four units. The connector includes a hook member for connecting together adjacent vertical members of frames of adjacent wall panel units at a lower portion thereof. A draw naught for connecting together adjacent vertical members of frames of adjacent wall panel units and an odd proportion thereof is provided by vertical displacement thereof.

With respect to problems resulting from potential variable distances between electrical devices of an electrical connector assembly or power distribution system, certain of these problems could be overcome by the use of extension conductors (within jumper cable assemblies) having sufficient length to connect the electrical devices. However, the use of such “maximum length” conductors is expensive and can result in unsightly and sometimes dangerous arrays, with resultant entanglements of the cable assemblies.

To avoid the use of such inefficient conductors, it is possible to interconnect the series of shorter length conductors as necessary, so as to provide requisite electrical power. Such interconnections can also result, however, in a relatively less aesthetically pleasing environment. To enhance the aesthetics, “electrical junction” or energy conductors of prescribed length extending from within can be employed. Such boxes can also be used to insulate splice connections between conductors.

However, a primary problem exists when electrical conductors and interconnection assemblies are designed so as to “tightly” connect these devices. Specifically, when manufacturing and “laying out” products such as modular office systems and associated electrical equipment, it is difficult to achieve the precision tolerances necessary to incorporate electrical conductors having an “exact” length. In addition, precision cutting and splicing of the actual electrical conductors is often difficult to achieve. This would be especially true if conductors were to be spliced together “on-site.” In addition, with conductor temperature variations resulting from environmental characteristics and the conductors carrying various magnitudes of electrical current, expansion and contraction of the conductors must also be taken into account.

A substantial advance with respect to overcoming the foregoing problems in modular power distribution systems and electrical connector assemblies is disclosed in Byrne, U.S. Pat. No. 4,579,403 issued Apr. 1, 1986. As disclosed herein, an electrical junction assembly provides for expansion and retraction of an electrical outlet or connector. The junction assembly includes a main housing with a conduit box, and with a flexible conduit interconnecting the connector and box. Incoming wires are received within an insulated connector receptacle, and thereat spliced to conductive wires received within the conduit and terminating at the connector. The conductive wires are coiled within the main housing so as to allow slack for purposes of expansion and retraction of the connector and conduit. In another embodiment, electrical cable is coiled around an elliptically configured center support within an expansion box. This allows expansion through opposing conduit portions with automatic retraction when external forces are removed from the conduit portions.

Another advance in the modular system art is disclosed in Byrne, U.S. Pat. No. 5,041,002 issued Aug. 20, 1991. As disclosed therein, electrical junction assemblies are provided within an office environment having removable wall panels. The junction assemblies include conduits of adjustable length disposed in raceways near the lower edge of the panels. One of the embodiments disclosed in the patent describes an adjustable length junction assembly having a telescoping conduit to accommodate wall panels of different dimensions and to facilitate the placement of electrical outlets at appropriate locations. One type of telescoping conduit comprises two overlapping conduit sections of generally rectangular cross section, forming an inner spatial area for retaining access wiring in a safe position. Another type of telescoping conduit comprises a conduit section of generally rectangular cross section and a generally flat multi-wire cable extending into the rectangular cross section conduit section, so as to allow for lengthwise adjustability of the assembly. In a still further embodiment, an extendable flexible conduit is connected to a rigid connector assembly provided with an inner spatial area to accommodate access wiring, and to allow wiring to move into and out of the connector assembly by extension and retraction of the extendable flexible conduit. This connector assembly is arranged to provide an electrical power outlet at an appropriate location.

Byrne, U.S. Pat. No. 5,096,434, issued Mar. 17, 1992, discloses an electrical interconnection assembly for use in wall panels of a space divider wall system. The system includes junction blocks having several receptacle connectors, so as to provide a plurality of electrical outlets on both sides of a wall panel. The junction block is connected by means of conduits extending from both ends of the junction block to oppositely directed connector blocks for connection to adjoining panels. The assembly of the junction block and connector blocks allows electrical power to be supplied to one end of the panel and conducted to and through the junction block to other panels. The receptacle connectors on the junction block each have one type of terminal configuration, e.g., a female electrical terminal configuration. One of the connector blocks is provided with the identical terminal configuration. The other connector block is provided with a matching terminal configuration, e.g., a male electrical terminal configuration. When two wall panels are joined at their respective edges, the male connector block may be readily connected to the female connector block in the adjacent panel. When two panels are joined to a third panel, all at one point, the arrangement of this invention allows the male connector block to be connected to the female connector block of one of the other two panels, and the male connector of the other of the two panels may be connected to one of the receptacle connectors of the junction block on either of the other two panels, in this manner establishing a three way interconnection arrangement. In a similar fashion, a fourth, or other additional panels may be added to the junction and plug into receptacle outlets of other panels in order to provide an arrangement of panels that is totally interconnected, electrically.

In the modular office systems or power distribution systems known in the prior art, various types of structures can be utilized for the electrical terminals themselves. As earlier described, most of these modular office systems and power distribution systems utilize male and female terminals. However, the specific structural configurations of these terminals often differ from system to system. One advance in the art of terminal structure and assembly is disclosed in Byrne, U.S. Pat. No. 4,990,110 issued Feb. 5, 1991. Therein, an electrical contact unit, in one embodiment, has a series of four electrical receptacles. Each of the receptacles includes upper and lower cantilever members. Upper lateral arms are interconnected by an upper bridge portion, and corresponding lower lateral arms are connected by a lower bridge portion. The upper arms and upper bridge portion provide a pair of contact surfaces or edges. Correspondingly, the lower lateral arms and lower bridge portion also form a pair of lower contact surfaces or edges. An upper cantilever member is positioned inwardly of the upper lateral arms. A lower and inner cantilever member is disclosed directly below the upper cantilever member, and is located in a spatial area formed by the lower lateral arms and lower bridge portion. The upper cantilever member is shaped so as to form a contact surface on a lower surface thereof. Correspondingly, the lower cantilever member is shaped to also form a contact surface.

Particularly with respect to the electrical connection assemblies and power distribution systems utilized within raceways of wall panels and the like, it is typically necessary to somehow securely mount elements of the distribution system to structures associated with the wall panels themselves. For example, in a power distribution system having a series of junction blocks and jumper cable assemblies, it is known to securely mount the junction blocks to wall panel raceways, either at the top or the rear of the junction blocks. One example of such a mounting assembly is disclosed in Byrne, U.S. Pat. No. 5,259,787 issued Nov. 9, 1993. The patent discloses a junction block mounting assembly, for mounting a junction block within a raceway. The assembly includes a cantilever beam formed on an outer wall of the junction block. This beam is provided with a transversely extending channel for engagement with a support structure. The beam is attached to the junction block by means of a resilient hinge section, and is provided with a first arm section extending between the hinge section and the channel, and a second arm section extending beyond the channel. The first arm section has a sloping surface sloping away from the outer channel between the hinge section of the panel. The second armed section has a sloping surface sloping toward the wall beyond the channel. The surfaces will contact a mounting rail or similar structure during installation of the junction block. In this manner, the hinged cantilever beam is deflected until the rail is in alignment with the channel for engagement with the structural support member.

### SUMMARY OF THE INVENTION

In accordance with the invention, a block mounted adjustable end assembly is adapted for use in interconnecting electrical apparatus to electrical power. The end assembly includes a first end jumper cable assembly, with the cable assembly having a series of conductive wires. The conductive wires carry electrical power. A junction block assembly is coupled to the first end jumper cable assembly for providing a user with access to electrical power from the conductive wires. The junction block assembly includes at least one junction block. A second end jumper cable assembly is connected to the junction block assembly. The second end jumper cable assembly has the conductive wires extending therethrough. The second end jumper cable assembly also has a flexible conduit adjustable in length so as to be extendable and retractable relative to the junction block assembly.

The junction block assembly also includes an adjustment end block connected between the junction block and the flexible conduit of the second end jumper cable assembly. The adjustment end block includes an interior spatial area within which a storage excess of the conductive wires can be stored. When the flexible conduit of the second end jumper cable assembly is extended, the storage excess of the conductive wires provides slack for the conductive wires to be extended correspondingly within the conduit of the second end jumper cable assembly.

The storage excess of the conductive wires can be curled in a loop within the interior of the adjustment end block. The adjustment end block can include a rear adjustment end block housing and a front adjustment end block cover. The junction block can include a front half junction block housing in a rear half junction block housing. The rear half junction block housing can be formed integral with the rear adjustment end block housing.

The second end jumper cable assembly can include a male end connector having male blade terminals. The conductive wires can be fixedly secured to individual ones of the male blade terminals within the male end connector.

The junction block can also include at least one side recessed area for receiving an outlet receptacle block. The outlet receptacle block can include outlet receptacles receiving power from the conductive wires. The front half junction block housing can include the side recess for receiving the electrical outlet receptacle block. The rear half junction block housing can also include at least one side recess for receiving a further outlet receptacle block. The further outlet receptacle block includes outlet receptacles receiving power from the conductive wires. The conductive wires can extend between the front half junction block housing and the rear half junction block housing.

In accordance with other aspects of the invention, the end assembly can include a series of H-shaped female connector sets positioned within the junction block and electrically connected to the conductive wires, for supplying power to electrical outlet devices coupled to the junction block. The junction block assembly can also include a connector assembly mounted to a top wall of the junction block, and adapted to secure the junction block assembly to a physical structure separate from the block mounted adjustable end assembly.

The junction block assembly also includes a first junction block end connector connected to the first end cable, with the conductive wires extending through the first junction block end connector. The assembly also includes a second junction block end connector having an open female connector housing for receiving female terminals. A second junction block adjustable end cover is secured at least partially around an end of the junction block and an end of the adjustment end block.

The second end jumper cable assembly includes a conduit connector which secures the second end jumper cable assembly to one end of the adjustment end block. A conduit connector can be connected to one end of the adjustment end block, with the conductive wires extending therethrough. A male end connector can be connected to the flexible and extendable conduit, with the series of conductive wires terminating therein with a set of male terminals. When the flexible and extendable conduit is extended, the male end connector is also extended and the storage excess of the conductive wires provides slack for the conductive wires to be extended within the flexible and extendable conduit.

### BRIEF DESCRIPTION OF THE DRAWINGS

The invention will now be described with reference to the drawings, in which:

FIG. 1 is a prior art, fragmentary elevation view of a plurality of adjacent wall panels and electrical connection assemblies arranged in the panels;

FIG. 2 is a prior art, enlarged perspective view of one of the electrical interconnection assemblies of FIG. 1;

FIG. 3 is a prior art cross-sectional view taken along lines 3-3 of FIG. 2;

FIG. 4 is a prior art, enlarged perspective view of an outlet receptacle shown in FIG. 1;

FIG. 5 is a prior art, side elevation view of the outlet receptacle of FIG. 4;

FIG. 6 is a prior art, fragmentary plan view of raceway areas of four wall panels, illustrating wall panel interconnections;

FIG. 7 is a prior art, fragmentary cross-sectional view taken along lines 7-7 of FIG. 2;

FIG. 8 is a prior art, perspective view of a receptacle contact blade shown in FIG. 7;

FIG. 9 is an upside down rear, elevation view of a block mounted adjustable end system in accordance with the invention;

FIG. 10 is a plan view of the adjustable end system shown in FIG. 9;

FIG. 11 is a left-side end view of the adjustable end system shown in FIG. 9;

FIG. 12 is a front, elevation view of the adjustable end system shown in FIG. 9;

FIG. 13 is a right-side end view of the adjustable end system shown in FIG. 9;

FIG. 14 is a bottom view of the adjustable end system shown in FIG. 9;

FIG. 15 is a right, upper perspective view of the adjustable system shown in FIG. 9;

FIG. 16 is a perspective view of the adjustable end system shown in FIG. 9, with the perspective view being similar to the view of FIG. 15, but rotated 180° relative thereto;

FIG. 17 is an exploded, perspective view of the adjustable end system shown in FIG. 9;

FIG. 18 is a perspective view of the end system shown in FIG. 9, with the perspective view being substantially identical to the view of FIG. 15; and

FIG. 19 is a perspective view of the adjustable end system shown in FIG. 9, with the perspective view being similar to the view of FIG. 18, but showing the capability of one of the cable conduits to be extended so as to adjust the length of the entire system.

### DESCRIPTION OF THE PREFERRED EMBODIMENT

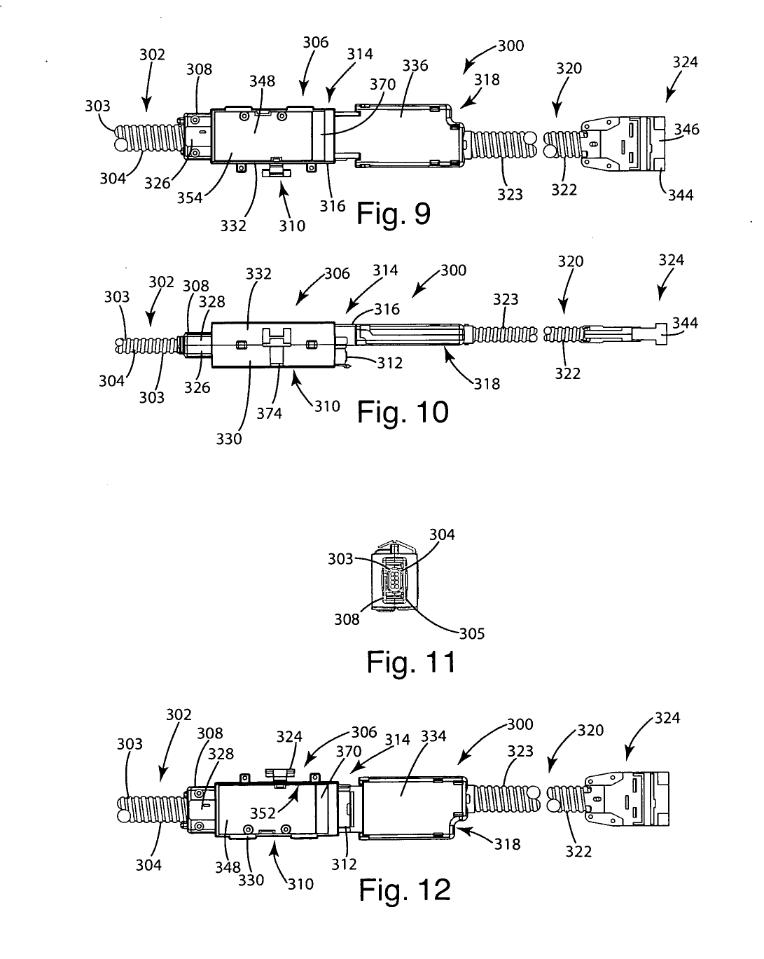

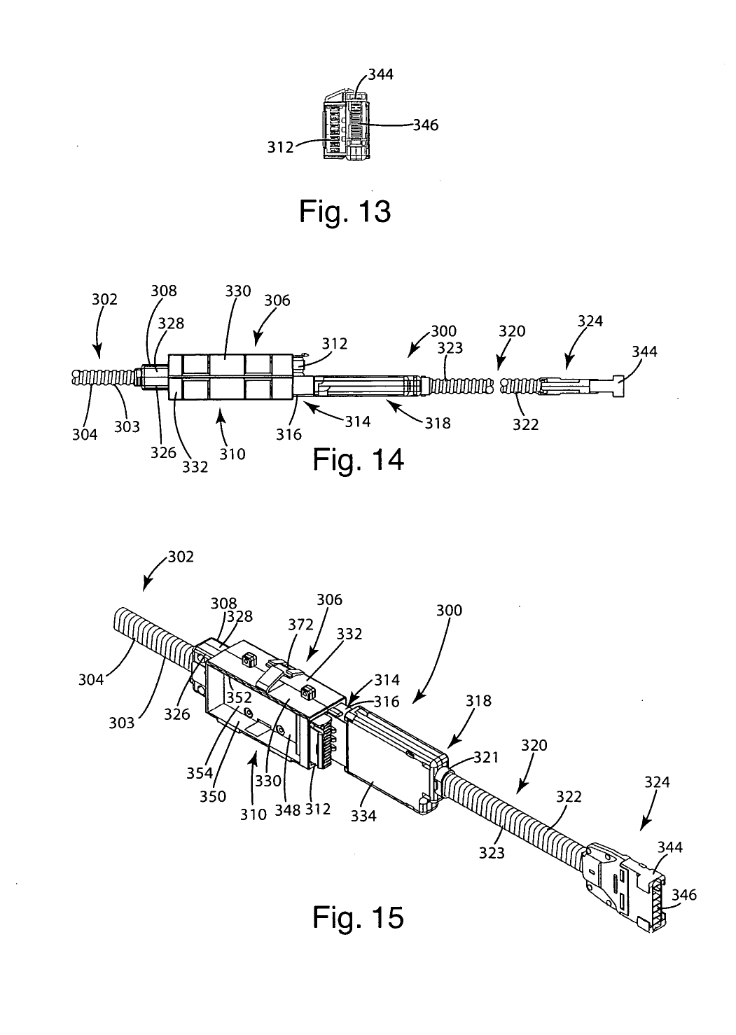

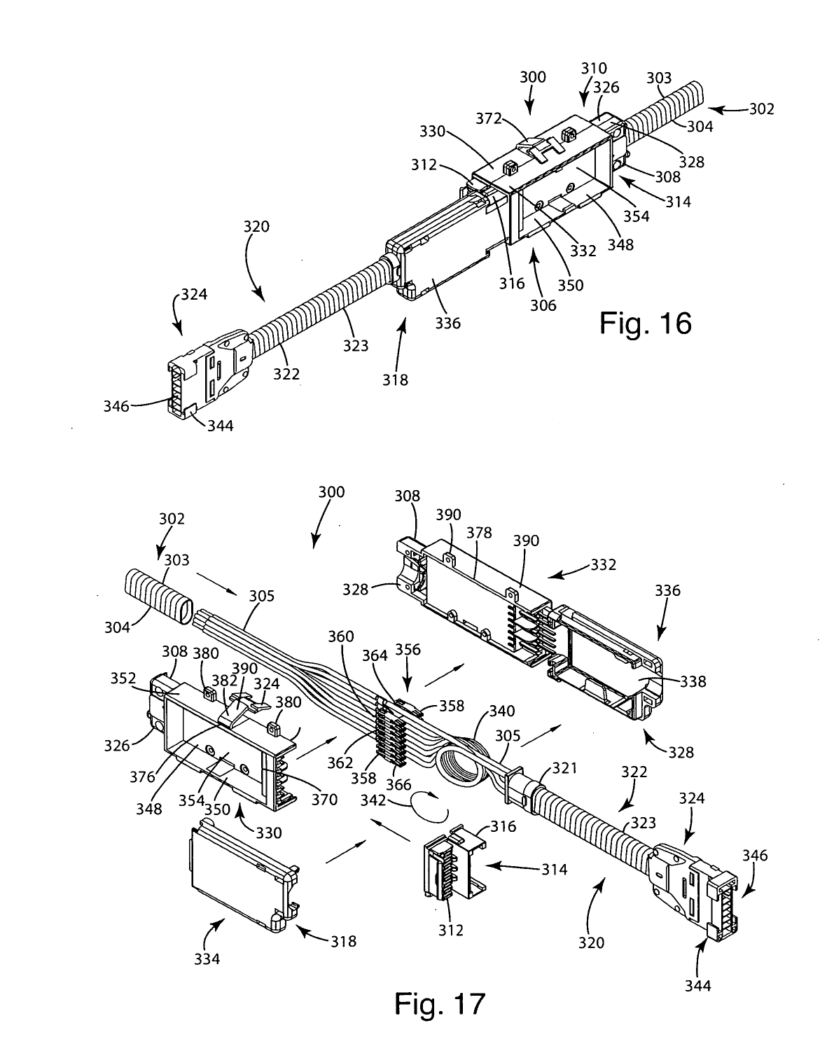

The principles of the invention are disclosed, by way of example, in a power distribution system or electrical interconnection assemblies having a block mounted adjustable end system as illustrated in FIGS. 9-19. The block mounted adjustable end system advantageously provides the capability of permitting extension and retraction of the cable conduit of a jumper cable assembly, so as to adjust the overall length of the adjustable end system. Further, adjustable end systems in accordance with the invention advantageously provide for a storage area for excess length of the cable wires within a junction block sub assembly which is fixedly secured to the junction block proper.

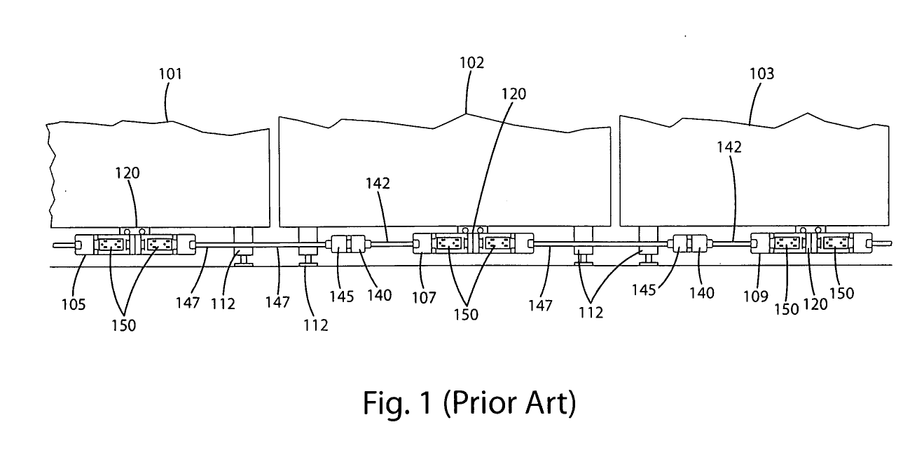

For purposes of describing configurations where power distribution systems, electrical connection assemblies, junction blocks and jumper cable assemblies can be utilized, the following paragraphs describe a prior art electrical interconnection assembly which is adapted for use within wall panels of a space divider wall system. This prior art electrical interconnection assembly is shown in the drawings of FIGS. 1-8, as described in subsequent paragraphs herein. Specifically, FIGS. 1-8 depict a junction block with several receptacle connectors, so as to accommodate a series of electrical outlets on both sides of a wall panel. The junction block is connected by means of conduits extending from both ends of the junction block to associated connector blocks for connection to adjoining panels. This assembly is disclosed in significant detail in Byrne, U.S. Pat. No. 5,096,434 issued Mar. 17, 1992, and generally described in the “Background Art” section of this document.

FIG. 1 is a fragmentary elevational view of adjacent modular wall panels 101, 102, 103 of a rearrangeable wall system. The wall panels are provided with electrical interconnection assemblies 105, 107 and 109 in a raceway area formed along the lower edge of panels 101, 102 and 103. Each of the panels is provided with substantially flat support legs 112 which allow for passage of electrical conduits in the raceway. Raceway covers, customarily used. have been omitted from the drawing in FIG. 1 to better show the electrical junction assemblies. Each of the electrical interconnection assemblies 105, 107, and 109 is provided with a junction block 120, a female electrical connector block 140 and a matching male connector block 145. The connector blocks 140, 145 are connected to associated junction blocks 120 by means of conduit sections 142 and 147, respectively. Each of the junction blocks 120 is shown in FIG. 1 to be provided with a pair of electrical outlet receptacles 150. Junction blocks 120 are double sided and corresponding pairs or outlet receptacles are provided on the opposite side of each of the wall panels 101, 102 and 103 (not shown in the drawing) to allow various electrical equipments to be plugged into the outlets from either side of the panel.

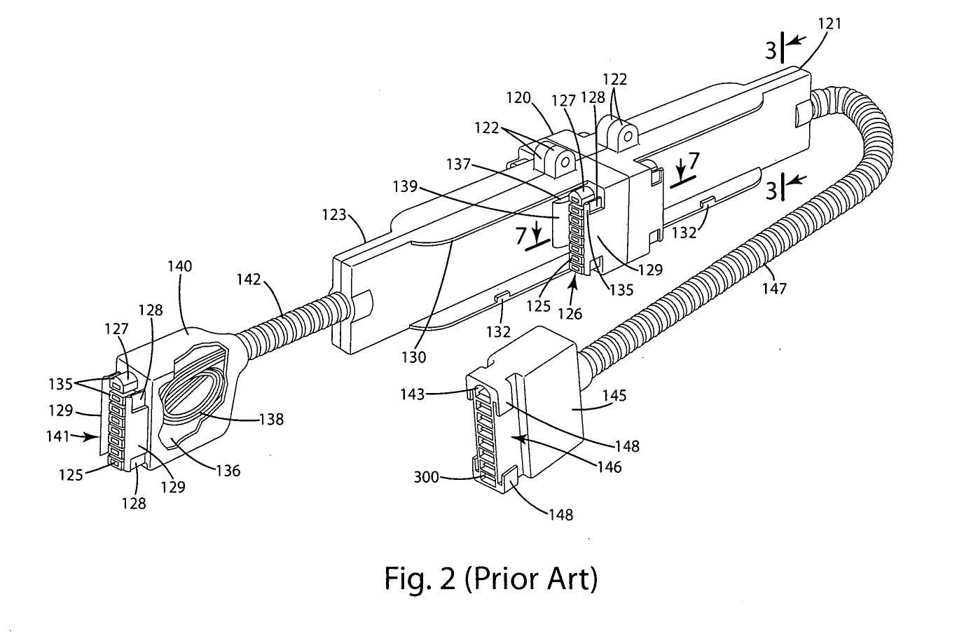

FIG. 2 is an enlarged perspective view of one of the electrical interconnection assemblies, for example assembly 107. The junction block 120 is provided with support lugs 122 by which the junction block is supported by standard fasteners extended through support tables extending from the bottom edge of the wall panel, e.g., wall panel 102. Junction block 120 comprises an elongated housing having opposing ends 121 and 123 and a symmetrical center section comprising four female receptacle connectors 126. Only one of the receptacle connectors 126 is fully exposed in FIG. 2. There is a pair of connectors 126 on each side of the housing and the connection on each side face in opposite directions. Support flanges 130 are provided adjacent each of the female connectors to provide support for electrical outlet receptacles engaged with the connectors 126. In this manner, junction block 120 is adapted to support four electrical outlet receptacles, two on each side of a wall panel to which junction block 120 is attached. The junction block assembly further comprises end connector block 140, provided with a female connector 141, and connected via a standard electrical conduit 142, which may be a flexible conduit, to end 123 of junction block 120. Similarly, connector block 145, provided with a male connector 146 is connected via flexible conduit 147 to end 121 of junction block 120. In a straight line connection arrangement, as depicted for example in FIG. 1, wherein a plurality of panels are positioned adjacent each other, electrical power is transmitted between panels by connection of male connector block 145 to female connector block 140 of the adjacent junction assembly.

Electrical power is transmitted through the junction assembly by means of electrical wires disposed in the conduits 142, 147, terminated on connectors 141 and 146, respectively, and connected to receptacle connectors 126 in junction block 120. Accordingly, electrical power is transmitted through interconnecting panels and is at the same time made available at electrical outlet receptacles in each panel. Conduit 147, provided with the male connector block 145, may be a fixed-length conduit and conduit 142 may be of a length such that female connector block 140 is positioned at substantially the same distance from the panel edge in each panel independent of the width of the panel. Thus, female connector block 140 will always be accessible to male connector block 145 independent of the width of the panels. To accommodate panels of different widths, conduit 142 may be an expandable flexible conduit, such as are well known in the art. In that case, connector block 140 may be provided with an inner spatial area 136, as shown in a partially broken-away view in FIG. 2. The inner spatial area 136 is provided for storage of excess length of electrical wiring 138 in a coiled or other configuration. The excess length of electrical wiring 138 may be withdrawn when conduit 142 is expanded to an extended length. This arrangement is similar to that disclosed in my earlier patent, U.S. Pat. No. 4,579,403 (dated Apr. 1, 1986) and entitled ELECTRICAL JUNCTION ASSEMBLY WITH ADJUSTABLE CONNECTORS.

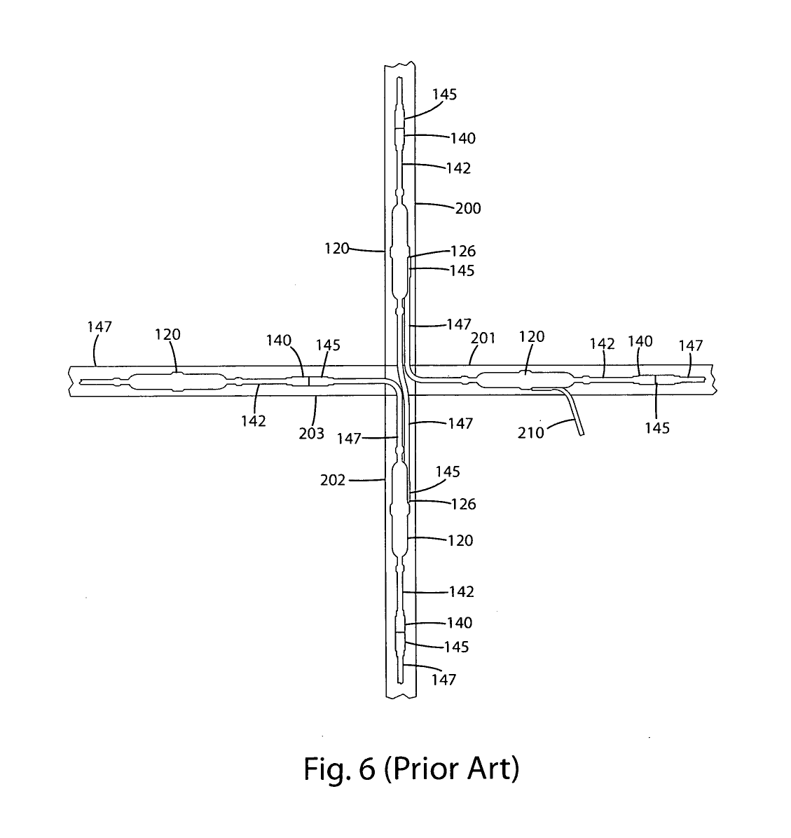

The conduit 147 is preferably a flexible conduit which may be bent to accommodate a connection to adjacent panels which are disposed at angular positions with respect to each other, rather than in a straight line. The junction assemblies of this invention readily accommodate an arrangement in which three or more panels are disposed in an intersecting relationship, as will be discussed further herein with respect to FIG. 6. In such a configuration, the male connector block 145 of one of the panels may be connected to one of the female receptacle connectors 126 of a junction block assembly in an adjacent wall panel. For this purpose, the female connector 141 of connector block 140 and female receptacle connectors 126 on junction block 120 have been made identical. Similarly, the male connector 146 on connector block 145 has been made identical to the male connector of electrical outlet receptacle 150, shown in FIG. 1. Greater detail of the receptacle 150 is shown in FIG. 4 and is described below. As may be seen from FIG. 2, the female connectors 126 and 141 are each provided with a pair of side flanges 129 having upper and lower recessed areas 128, for engagement with flanges 148 of a male connector to provide a locking arrangement. FIGS. 129, which are made of a resilient plastic material and formed integral to the housing to which they are connected, are provided with an outwardly extending inclined end surface 135. When surfaces 135 are engaged by flanges such as flanges 148 of connector 146 on connector block 145, the flanges 129 will be deflected inward, allowing flanges 148 of the male connector to engage recesses 128 to provide a locking engagement of the male and the female connectors. A protuberance 137 is provided with a generally rounded edge surface 139 and acts as an entry guide as a male connector is engaged in female connector 126. The female connectors 126, 141 are each provided with a plurality of female connector terminals 125 and a key lug 127. Male connector 146 is provided with a plurality of male connector terminals 149 and an opening 143 for receiving key lug 127.

The electrical outlet receptacle 150, shown in FIG. 4, is provided with male connectors 151 at both ends, allowing the receptacle to be plugged into any one of the four female receptacle connectors 126 of junction block 120. As shown in FIG. 2, junction block 120 is provided with upper and lower support flanges 130 to support receptacles 150 in each of the four female connectors 126. The lower support flanges 130 are provided with a locking flange 132. The receptacle 150 is provided with a spring latch 152 disposed in recess 154 in the surface 156 of receptacle 150. Surface 156 engages one of the lower support flanges 130 when the receptacle 150 is installed in the junction block 120. The locking flanges 132 will be aligned with the recess 154 when the receptacle 150 is inserted between flanges 130, causing the spring latch 152 to be depressed. The receptacle 150 may then be moved to either the left or to the right to engage one of the female connectors 126. Recesses 158 are provided in receptacle 150 to accommodate locking flange 132 and movement to either the left or to the right by a sufficient distance will cause the spring latch 152 to be moved past locking flange 132, causing the spring latch 152 to return to its extended position. Hence, receptacle 150 will be retained in a locked position. The receptacle may be removed by depressing spring latch 152 and sliding the receptacle 150 to either left or right to align the locking flange 132 with recess 154. FIG. 5 is a right-hand elevation of receptacle 150 showing a right-hand elevation or receptacle 150 showing right-hand male connector 151.

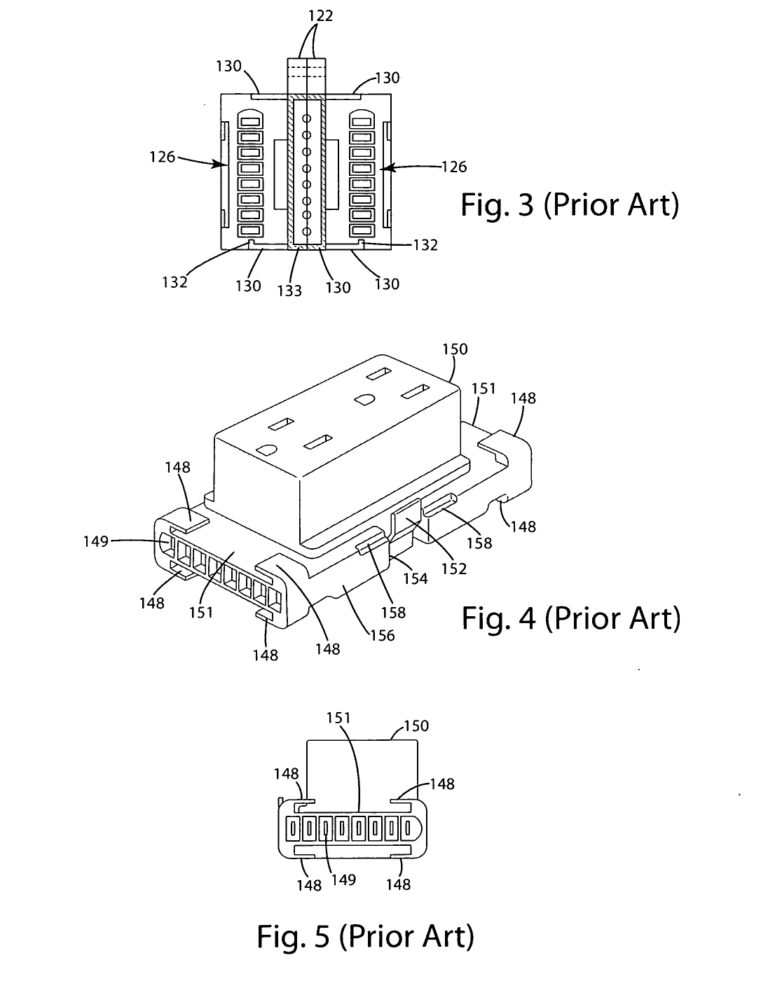

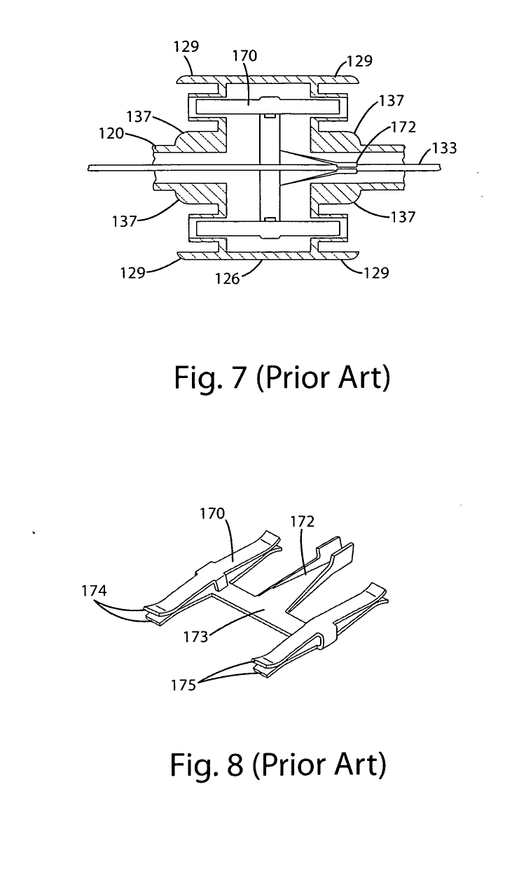

FIG. 3 is a cross-sectional view of junction block 120 taken along line 3-3 of FIG. 2. FIG. 3 shows two of the four receptacle connectors 126 of connector block 120. One of the two connectors 126 shown in FIG. 3 is disposed on each side of the central housing section 131, which contains a plurality of wires 133. An eight-wire system is shown in this illustrative embodiment. Each of the male and female connectors are provided with eight separate terminals, and eight separate electrical wires 133 extend through the connector blocks 140, 145, the conduits 142, 147 and the central section 131 of the junction block 120. By way of example, these may include two ground terminal wires, three neutral wires and three positive wires representing three separate circuits, with a shared ground for two of the circuits. Similarly, 10- or 12-wire systems may be readily accommodated, having corresponding number of terminals on each of the connectors and providing a greater number of separate circuits. The four female receptacle connectors 126 are each connected to the wires 133 by means of a plurality of contact blades, described later herein with respect to FIGS. 7 and 8. Each wire, together with the connector block terminals and receptacle connector terminals to which it is connected, is referred to herein as a circuit element. A particular circuit may be selected for use by one of the receptacles 150 by appropriate wiring connections internal to the receptacle. Since all of the circuits are connected to each one of the receptacle connectors 126 of junction block 120, a connector block 145 of an adjacent panel, equipped with a male connector, may be connected to any one of the receptacle connectors 126. In this manner, electrical power may be provided to receptacle connectors to junction block 120 and to associated connector blocks 140, 145 and hence to any adjacent panels to which these connectors may be connected. Similarly, a connector block 145 equipped with a male connector connected to one of the female connectors 126 may receive electrical power for distribution to a panel to which the connector block 145 belongs. Such interconnecting arrangements are described further herein with respect to FIG. 6.

FIG. 7 is a fragmentary cross-sectional view along line 7-7 of FIG. 2. Shown in FIG. 7 is a contact blade structure 170 which is one of eight such blades disposed in central housing section 131. Each such blade is in electrical contact with one of the conductors 133. Connection to conductor 133 is made by means of a crimped connection of blade extension member 172 to conductor 133. As may be more readily seen from the perspective view of FIG. 8, the extension member 172 is part of a center section 173 which is connected to left-hand upper and lower contact blades 174 and right-hand upper and lower contact blades 175. The upper and lower contact blades on each side from the female opening part of the conductor 126 for engagement with blades of a male connector.

FIG. 6 is a fragmentary plan view of raceway areas of four wall panels illustrating the connections of interconnection assemblies of the invention in a configuration in which the four panels are disposed at right angles to each other. As will be apparent from the following description, the specific angle at which the panels are positioned is not particularly significant. Furthermore, the invention is equally applicable to a three-panel configuration or a five-panel configuration disposed at right angles to each other. Each of the four panels is provided with an interconnection assembly, as shown in FIG. 2, comprising a junction block 120, a male connector block 145, and a female connector block 140 attached to the junction block 120 by means of flexible conduits 147 and 142, respectively. The junction block 120 is disposed within each panel raceway near one edge of the panel. Panels 200, 201, 202 are positioned such that the end at which these panels are joined to other panels is the end near which the junction block 120 is positioned. One of the panels, panel 203, is positioned with an opposite orientation in which the end near which the junction block 120 is located is positioned opposite the point of junction of the four panels. The flexible conduit 147, provided with the male connector block 145, extends beyond the end of the panel in which it is positioned, and the flexible conduit 142, provided with a female connector block 140, is terminated just short of the end of the panel. Thus, as is also shown in FIG. 1, a connection is made between panels by extending the flexible conduit 147 with male connector block 145 into the raceway area of the adjacent panel to engage the female connector block 140 at the end of flexible conduit 142. In the configuration of FIG. 6, the male connector block 145 of panel 202 and its associated flexible conduit 147 extend into the raceway area of panel 202 to engage female connector block 140 of panel 203. It will be apparent that the connection as shown between panel 202 and 203 may be made whenever these panels are adjacent and independent of the angle at which the panels are disposed with respect to each other. In the configuration of FIG. 6, the flexible conduit 147, with its male connector block 145, associated with the panel 200 are extended into the raceway area of panel 202 for engagement with one of the female receptacle connectors 126 of junction block 120 in panel 202. In this manner, an electrical connection is established among the junction blocks of the three panels 200, 202, and 203. Thus, electrical power provided from an external source to any one of these three may be distributed to the other two by means of the connection arrangement shown by way of example in FIG. 6. In the arrangement of FIG. 6, flexible conduit 147 and its male connector block 145 of panel 202 is connected to one of the female connectors 126 of junction block 120 of panel 200 thereby establishing an electrical connection between panels 200 and 201. This connection, in combination with the other connections shown in FIG. 6 and described in the previous sentences, completes an arrangement for establishing an electrical connection from any one of four panels to the entire four-panel configuration. Additional connections may be envisioned by connections of male connectors 145 from other panels into additional ones of the female receptacle connectors 126 of the junction blocks 120 of any of the panels 201 through 203, should one choose to provide an arrangement of more than four intersecting panels. Furthermore, additional conduits, such as conduit 210 shown in FIG. 6, may be connected by means of a male connector to any of the receptacle connectors 126 to provide electrical power to lamps or other fixtures.

The invention will now be described with respect to a block mounted adjustable end assembly 300 as illustrated in FIGS. 9-19. As earlier described, the end assembly advantageously provides the capability of permitting extension and retraction of the cable conduit and associated conductive wiring of a jumper cable assembly, so as to adjust the overall length of the adjustable end assembly 300. Also, the adjustable end assembly 300 in accordance with the invention advantageously provides for a storage area for excess length of the conductive wiring within a junction block sub assembly or adjustment end block which is fixedly secured to the junction block proper.

Turning specifically to the drawings, FIGS. 9-14 illustrate engineering views of the block mounted adjustable end assembly 300 in accordance with the invention. As shown in FIGS. 9-12 and 14, the block mounted end assembly 300 includes a first end jumper cable assembly 302 mounted to the left side (as viewed looking into the page containing FIGS. 9-14) of the assembly 300. The first end jumper cable assembly 302 includes a first end cable 304 shown only partially in the drawings. Although not shown in the drawings, attached to a far left end of the first end cable 304 would be a first end connector (not shown). This first end connector would typically be in the form of a female end connector having a female terminal set (again, not shown). The female terminal set would be connected to a series of conductors or conductive wires 305. These conductive wires 305 are shown from an end view (which is actually “cut off” as part of the partial view of the first end jumper cable assembly 302) as shown in FIG. 11. The conductive wires 305 extend completely through the adjustable end assembly 300, as primarily shown in FIG. 17. The number of conductive wires 305 will depend upon the particular system and the number of circuits with which the adjustable end assembly 300 is being used. For example, with the adjustable end assembly 300 shown in this particular embodiment, the number of conductive wires 305 is eight.

In addition to the conductive wires 305, the first end cable 304 includes conduit 303 which is shown as a separate component in FIG. 17. The conduit 303 provides a protective shielding or sheathing for the conductive wires 305.

In addition to the first end jumper cable assembly 302, the adjustable end assembly 300 includes a junction block assembly 306. The junction block assembly 306 includes, at one end, a first junction block end connector 308. The junction block end connector 308 is formed with a front half housing 326 and a rear half housing 328, as primarily shown in FIG. 17. The housings 326 and 328 can be secured together in any suitable manner and can also be fixedly secured to one end of the conduit 303. In this manner, the conductive wires 305 are received within and extend through the first junction block end connector 308.

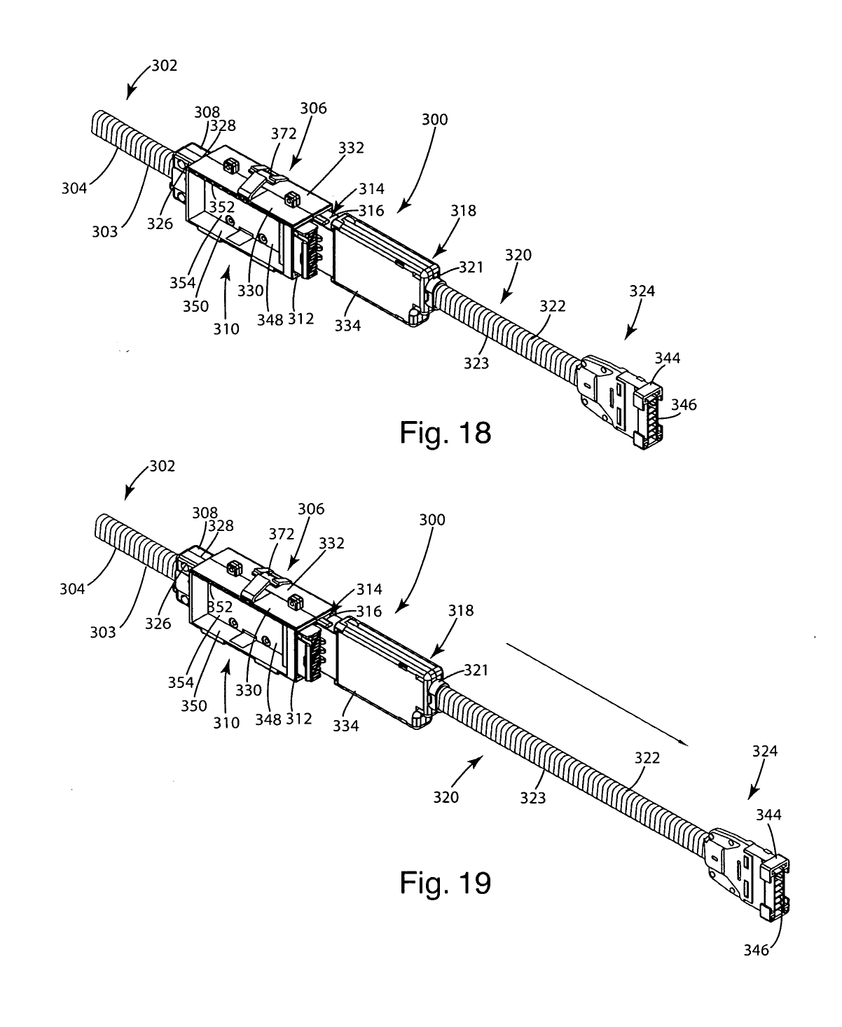

Integral with or otherwise fixedly secured to the first junction block end connector 308 is a junction block 310 which is somewhat conventional in design. Examples of junction blocks substantially similar to junction block 310 are disclosed in commonly owned Byrne, U.S. Pat. No. 6,036,516 issued Mar. 14, 2000 and commonly owned Byrne PCT Patent Application Serial No. US/2006/017321 published Mar. 8, 2007. Certain details regarding the junction block 310 will be described in subsequent paragraphs herein. At this time, it is sufficient to state that the junction block 310 has the capability of receiving a pair of electrical outlet receptacle blocks (not shown) on either side of the junction block 310. Such electrical outlet receptacle blocks (not shown) can be substantially similar to the receptacle block 150 previously described herein and illustrated in prior art FIGS. 4 and 5. As shown in FIG. 17, the junction block 310 can consist of a front half junction block housing 330 and a rear half junction block housing 332. The front half and rear half junction block housings 330, 332 can be fixedly secured together by any suitable means such as screws or other similar connecting means. When connected together, as shown, for example, in FIGS. 18 and 19, the conductive wires 305 extend through a spatial area which is substantially in between the half junction block housings 330, 332. This structure is made apparent from the exploded view of FIG. 17.

Attached to and fixedly secured to what could be characterized as the right side of the junction block 310 is a second junction block end connector 314. The second junction block end connector 314 is shown in a standalone configuration in FIG. 17. With reference to FIG. 17 and other drawings, the second junction block end connector 314 includes an open female connector housing 312. As described in subsequent paragraphs herein, a set of female terminals will extend into individual subhousings of the female connector housing 312, when assembled. In addition to the open female connector housing 312, the second junction block end connector 314 also includes a second junction block adjustment end cover 316. The second junction block adjustment end cover 316 is also shown in a standalone configuration in FIG. 17. The adjustment end cover 316 is adapted to provide a partial housing for the conductive wires 305 as they pass outwardly from the right side of the junction block 310.

In addition to the aforedescribed components, the block mounted adjustable end assembly 300 also includes an adjustment end block 318. The adjustment end block 318 is substantially shown in all of the drawings, with the exception of FIG. 11. The adjustment end block 318 includes, as illustrated in FIG. 17, a front adjustment end block cover 334 and a rear adjustment end block housing 336. The front cover 334 and the rear housing 336 can be fixedly secured together through any suitable connecting means, such as screws, pop rivets or the like. When connected together, the conductive wires 305 are positioned within the interior of the adjustment end block 318 formed by the cover 334 and housing 336. Also, as particularly shown in FIG. 17, the interior area 338 of the housing 336 has sufficient room so as to loop around and store excess sections of the conductive wires 305. This storage excess is identified in FIG. 17 as storage excess 340. The excess 340 is essentially “looped around” within the interior 338 in the direction shown by the circular formed arrow 342.

Connected to the right side of the adjustment end block 318 is a second end jumper cable assembly 320. The second end jumper cable assembly 320 includes a conventional conduit connector 321. The conduit connector 321 is connected to one end of the adjustment end block 318 and is connected at its other end to one end of a conduit 323. The conduit 323, along with the conductive wires 305 extending therethrough, form a second end cable 322 of the second end jumper cable assembly 320.

In addition to the conduit connector 321 and conduit 323, the second end jumper cable assembly 320 also includes a male end connector 324. The male end connector 324 is well known in the art and is shown, for example, in Byrne, PCT Patent Application US 2006/016485 published Nov. 16, 2006. The male end connector 324 includes a male connector housing 344, with a male terminal set 346 housed therein. The male terminal set 346 includes blades or male terminals which are connected in any suitable manner to corresponding ones of the ends of the conductive wires 305. The male end connector 324 is adapted to mechanically and electrically connect to a cooperating female end connector or other set of female terminals associated with a junction block, other jumper cable assembly or the like.

Returning to more specific details of components of the block mounted adjustable end assembly 300, the junction block assembly 306 includes the junction block 310 formed by a front half junction block housing 330 and rear half junction block housing 332. The junction block 310 can, if desired, be disposed within the raceway of a panel, such that opposite sides of the junction block can be exposed outside the raceway through raceway openings. The junction block 310 includes a pair of recesses 348. The recess 348 associated with the front half junction block housing 330 is shown in a number of the drawings, including FIG. 12. The recess 348 associated with the rear half junction block housing 332 is shown in FIG. 9. The recesses are utilized to mount one or more electrical outlet receptacle blocks or similar electrical power and/or communications outlets. The particular outlet receptacle blocks and communications ports are not shown in the drawings, and do not form any of the novel concepts of the invention. The receptacle blocks can provide power to electrical equipment (not shown) located in proximity to the adjustable end assembly 300. Each of the junction blocks 310 includes a lower wall 350, upper wall 352 and middle wall 354 which form each of the recesses 348. Further details associated with the structure of the junction block 310 and the entirety of the junction block assembly 306 can be found in my commonly owned patent Byrne, U.S. Pat. No. 6,036,516 issued Mar. 14, 2000.

Within the spatial area between the front half junction block housing 330 and the rear half junction block housing 332, the conductive wires 305 are received lengthwise and are coupled individually to corresponding ones of a female terminal connector set 356 as particularly shown in FIG. 17. The female terminal connector set 356 includes a set of eight individual female connectors 358. Each of the female connectors 358 has an H-shaped configuration and includes four female terminals 360. These female terminals 360 and female connectors 358 correspond to the contact blade structures 170 previously described herein as being part of the prior art and illustrated in FIGS. 7 and 8.

Continuing with respect to FIG. 17, the female terminal connector set 356, having the four sets of female connectors 358, with the female terminals 360, can be characterized as having a first set of female terminals 362, second set of female terminals 364, third set of female terminals 366 and fourth set of female terminals 368. The first set of female terminals 362, when the adjustable end assembly 300 is fully assembled, are received within a junction block receptacle connector housing 370 positioned within the recess 348 shown in FIG. 17. This first set of female terminals 362 will be utilized to electrically connect and energize an electrical receptacle outlet block (not shown) which can be inserted within the recess 348. Correspondingly, the second set of female terminals 364 can be positioned within another junction block receptacle connector housing (not shown) associated with the recess 348 on the opposing side of the junction block 310. These terminals are then adapted to electrically connect to a male terminal set associated with another electrical outlet receptacle block (not shown).

The third set of female terminals 366, again when the end assembly 300 is fully assembled, can be received within the open female connector housing 312 previously described herein and also shown in FIG. 17. This third set of female terminals 366 can then be utilized to electrically connect to a male end connector of a jumper cable assembly or similar components. The fourth set of female terminals 368 can remain unused or can be “clipped off” from the female terminal connector set 356.

As shown in a number of the drawings, including FIGS. 17, 18 and 19, the end assembly 300 also includes a connector assembly 372 for purposes of supporting the junction block 310 (and the associated remaining components of the end assembly 300) on a structural member (not shown) of a raceway within which the end assembly 300 is positioned. Various types of connector assemblies can be used, without departing from the spirit and scope of the novel concepts of the invention. For example, the connector assembly 372 is substantially described within commonly owned Byrne, U.S. Pat. No. 5,259,787 issued Nov. 9, 1993. The connector assembly 372 includes a latching device 374 constructed as a cantilever beam having one end attached to a hinge section 376. The hinge section 376 is attached to the upper wall 352 of the junction block 310. The latching member 374 is preferably made integral with the junction block 310 and may be constructed of a resilient plastic material, providing a restoring force at the hinged section 376 in a direction away from the upper wall 352. With respect to the latching member 374 and the assembly of the end assembly 300, it is apparent that the junction block 310 consists of a bipartite structure formed at two separate sections and joined along a center line 378. The latching member 374 is formed on the front half junction block housing 330. The latching member 374 comprises a first arm section 380 having a sloping surface 382 sloping upwardly away from the upper wall 352 and away from the hinged section 376 toward a slotted section provided with a transversely extending channel 384. The channel 384 engages a tab (not shown) or similar structural device associated with the raceway or panel, so as to prevent lateral movement of the junction block 310 relative to the structural member (not shown). The latching member 374 is further provided with a second arm section 386 extending beyond the channel 384 and having a sloping surface 388 sloping downwardly toward the upper wall 352 and away from the channel 384. In this manner, a releasable engagement can be made with the structural member. In addition, also shown are a set of lugs 390 through which connecting means such as screws or the like can be utilized to more fixedly secure the junction block 310 to a structural member associated with a raceway or panel.

With the foregoing, and again primarily with reference to FIG. 17, the adjustable end assembly 300 can be assembled by securing the conduit 303 around the conductive wires 305 at one end thereof. The junction block 310 can then be assembled by releasably securing (in any suitable manner) the front half junction block housing 330 to the rear half junction block housing 332. The second junction block end connector 314 can then be secured to the junction block 310. When the second junction block end connector 314 is thereby assembled, the adjustment end block 318 can then be assembled by connecting together the front adjustment end block cover 334 with the rear adjustment end block housing 336. When connected together, the storage excess 340 of the conductive wires 305 will be positioned within the interior 338 of the adjustment end block 318.

The conduit connector 321 can then be secured to a right side end of the adjustment end block 318. This securing of the conduit connector 321 thereby secures the second end jumper cable assembly 320 to the adjustment end block 318. As further shown in FIG. 17, the conductive wires 305 extend through the interior of the junction block 310, the interior of the adjustment end block 318 (with the looped storage excess 340) and then through the second end jumper cable assembly 320. The ends of the conductive wires 305 can then be appropriately received as male terminals within the male end connector 324 and the male connector housing 344.

In accordance with the invention, the conduit 323 associated with the second end jumper cable assembly 320 is retractable and extendable. FIG. 18 illustrates the cable 323 in a retracted position, while FIG. 19 illustrates the cable 322 in an extended position. The capability of providing this extension and retraction results from the existence and positioning of the storage excess 340 of the conductive wires 305 within the adjustment end block 318. That is, when the conduit 323 is retracted so as to minimize the length of the end assembly 300 (again, shown in FIG. 18), the amount of storage excess 340 is at its maximum within the adjustment end block 318. When it is desired to extend the length of the end assembly 300, the user can exert outwardly directed forces on the conduit 323, so as to cause the conduit to extend lengthwise as illustrated in FIG. 19. The conduit 323 is permitted to extend in this manner, as the result of the excess amount of the conductive wires 305 stored as storage excess 340 within the adjustment end block 318. In this manner, the adjustable end assembly 300 is capable of being extended and retracted in length, without requiring any excess storage of wires within outer end connectors or the like.

It will be apparent to those skilled in the pertinent arts that still other embodiments of adjustment end assemblies in accordance with the invention can be designed. That is the principles of adjustment end assemblies in accordance with the invention are not limited to the specific embodiment described herein. Accordingly, it will be apparent to those skilled in the art that modifications and other variations of the above-described illustrative embodiment of the invention may be effected without departing from the spirit and scope of the novel concepts of the invention.

1. A block mounted adjustable end assembly adapted for use in interconnecting electrical apparatus to electrical power, said adjustable end assembly comprising:
a first end juniper cable assembly, said cable assembly comprising a plurality of conductive wires, with said conductive wires carrying electrical power;
a junction block assembly coupled to said first end jumper cable assembly for providing a user with access to electrical power from said conductive wires, said junction block assembly comprising at least one junction block;
a second end jumper cable assembly connected to said junction block assembly and having said conductive wires extending therethrough, with said second end jumper cable assembly further having a flexible conduit adjustable in length so as to be extendable and retractable relative to said junction block assembly;
said junction block assembly further comprises an adjustment end block connected between said junction block and said flexible conduit of said second end jumper cable assembly, and having an interior spatial area within which a storage excess of said conductive wires can be stored; and
when said flexible conduit of said second end jumper cable assembly is extended, said storage excess of said conductive wires provides slack for said conductive wires to be extended correspondingly within said conduit of said second end jumper cable assembly.

2. A block mounted adjustable end assembly in accordance with claim 1, characterized in that said storage excess of said conductive wires are curled in a loop within said interior of said adjustment end block.

3. A block mounted adjustable end assembly in accordance with claim 1, characterized in that said adjustment end block comprises:
a rear adjustment end block housing; and
a front adjustment end block cover.

4. A block mounted adjustable end assembly in accordance with claim 3, characterized in that:
said junction block comprises a front half junction block housing and a rear half junction block housing; and
said rear half junction block housing is formed integral with said rear adjustment end block housing.

5. A block mounted adjustable end assembly in accordance with claim 1, characterized in that:
said second end jumper cable assembly further comprises a male end connector having male blade terminals; and
said conductive wires are fixedly secured to individual ones of said male blade terminals within said male end connector.

6. A block mounted adjustable end assembly in accordance with claim 1, characterized in that said junction block comprises at least one side recessed area for receiving an outlet receptacle block, said outlet receptacle block comprising outlet receptacles receiving power from said conductive wires.

7. A block mounted adjustable end assembly in accordance with claim 1, characterized in that said junction block comprises:
a front half junction block housing having a side recess for receiving an electrical outlet receptacle block, said outlet receptacle block comprising outlet receptacles receiving power from said conductive wires; and
a rear half junction block housing having at least one side recess for receiving a further outlet receptacle block, said further outlet receptacle block comprising outlet receptacles receiving power from said conductive wires.

8. A block mounted adjustable end assembly in accordance with claim 1, characterized in that:
said junction block comprises a front half junction block housing and a rear half junction block housing; and
said plurality of conductive wires extends between said front half junction block housing and said rear half junction block housing.

9. A block mounted adjustable end assembly in accordance with claim 1, characterized in that said end assembly further comprises a plurality of H-shaped female connector sets positioned within said junction block and electrically connected to said plurality of conductive wires, for supplying power to electric outlet devices coupled to said junction block.

10. A block mounted adjustable end assembly in accordance with claim 1, characterized in that said junction block assembly further comprises a connector assembly mounted to a top wall of said junction block, and adapted to secure said junction block assembly to a physical structure separate from said block mounted adjustable end assembly.

11. A block mounted adjustable end assembly in accordance with claim 1, characterized in that said junction block assembly further comprises a first junction block end connector connected to said first end cable, with said plurality of conductive wires extending through said first junction block end connector.

12. A block mounted adjustable end assembly in accordance with claim 1, characterized in that said assembly further comprises a second junction block end connector having an open female connector housing for receiving female terminals, and a second junction block adjustable end cover which is secured at least partially around an end of said junction block and an end of said adjustment end block.

13. A block mounted adjustable end assembly in accordance with claim 1, characterized in that said second end jumper cable assembly further comprises a conduit connector which secures said second end jumper cable assembly to one end of said adjustment end block.

14. A block mounted adjustable end assembly adapted for use interconnecting electrical apparatus to electrical power, said adjustable end assembly comprising:
a first jumper cable assembly comprising a conduit and having a plurality of conductive wires carrying electrical power extending therethrough;
a first junction block end connector connected to one end of said conduit of said first end jumper cable assembly, said plurality of conductive wires extending therethrough;
a junction block connected at one end to said first junction block end connector, and having said plurality of conductive wires extending therethrough;
a second junction block end connector connected to an opposing end of said junction block;
a plurality of H-shaped female terminal connectors having a plurality of sets of female terminals physically and electrically connected to said conductive wires;
an adjustment end block connected to said junction block and having an adjustment block interior within which excess length of said conductive wires can be stored;
a conduit connector connected to one end of said adjustment end block, and having said plurality of conductive wires extending therethrough;
a flexible and extendable conduit connected to said conduit connector and having said plurality of conductive wires extending therethrough;
a male end connector connected to said flexible and extendable conduit, and having said plurality of conductive wires terminating therein with a set of male terminals; and
when said flexible and extendable conduit is extended, said male end connector is also extended and said storage excess of said conductive wires provides slack for said conductive wires to be extended within said flexible and extendable conduit.
